(19) United States
(12) Patent Application Publication
(10) Pub. No.: US 2021/0012683 A1
(43) Pub. Date: Jan. 14, 2021

(54) CRIME SCENE EVIDENCE MARKING CARD SOLUTION

(71) Applicant: Vincent J Gerace, Jamestown, NY (US)

(72) Inventor: Vincent J Gerace, Jamestown, NY (US)

(21) Appl. No.: 16/510,704

(22) Filed: Jul. 12, 2019

(51) Int. Cl. G09F 1/10; G09F 1/02

(52) U.S. Cl. CPC G09F 1/10; G09F 1/02

(57) ABSTRACT

A marking system for marking evidence at a scene is provided including a plurality of markers having measurement indicia, a sequential marker identification, and an index for indication of orientation provided thereon. A plurality of holders is also provided for holding the plurality of markers. The plurality of holders includes a base for resting on a relatively flat surface and a groove for holding the marker in place. Each marker of the plurality of markers is adapted to be placed adjacent to a separate piece of evidence at a scene.

### BRIEF DESCRIPTION OF THE DRAWINGS

FIGS. 1A and 1B show prior art evidence marker solutions;

FIG. 2 illustrates one embodiment of the present evidence marker;

FIGS. 3A-3D illustrate how the present evidence marker may be securely affixed to evidence;

FIGS. 4A and 4B illustrate one embodiment of how the present evidence markers may be securely fastened to surfaces such as the fender of an automobile;

FIG. 5A illustrates the present evidence marker wherein a cone provides a stable means of mounting an evidence marker;

FIG. 5B depicts the present evidence marker mounted to a plastic holder;

FIG. 6 shows an enlarged view of the present evidence marker holder; and

FIG. 7 provides the present evidence marker packaged as a crime scene investigation kit.

### DETAILED DESCRIPTION

The present evidence markers can be made from paper or plastic card stock or any other suitable printable medium. The size and shape of the markers is flexible. Shape can be customized to reflect the logo or badge configuration of the law enforcement agency (LEA) involved. The most common shapes include rectangular, round, diamond, triangular but any geometric shape can be used.

Markers may be custom designed and printed by the LEA or supplier in any desired quantity. Holders and stands may be specifically designed and produced for use with the markers, or improvised from available materials.

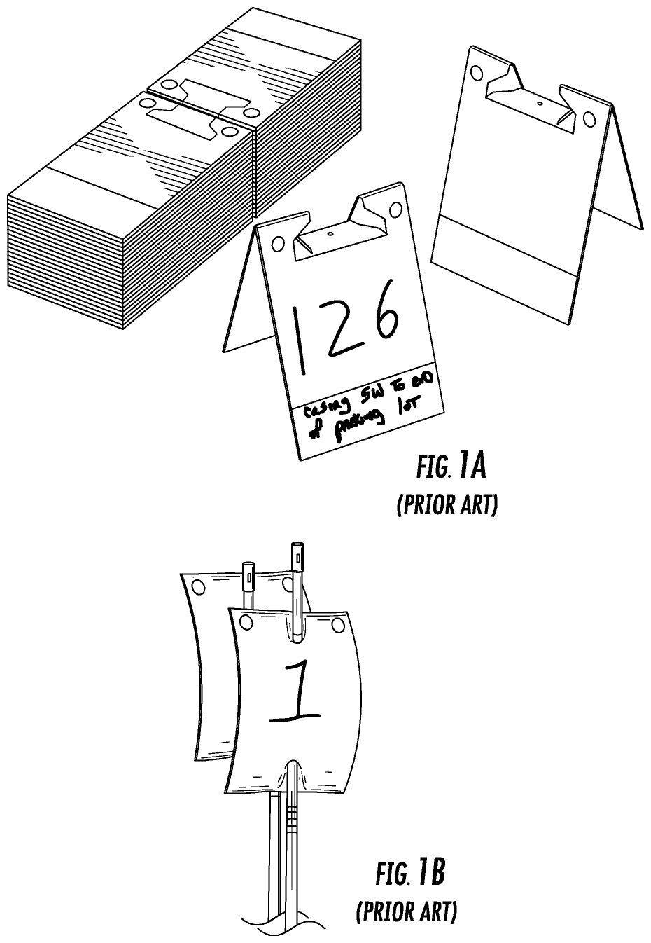

Turning to the drawings, FIGS. 1A and 1B depict two prior art evidence markers used for marking evidence at crime scenes. FIG. 1A, utilizes stand-alone tent-like cards, providing a space for an investigator to designate the article of evidence with an identifier such as a numeral, as well as other pertinent information. FIG. 1B depicts another type of evidence marker card utilizing a pole-like structure to secure the marker adjacent to an article of evidence.

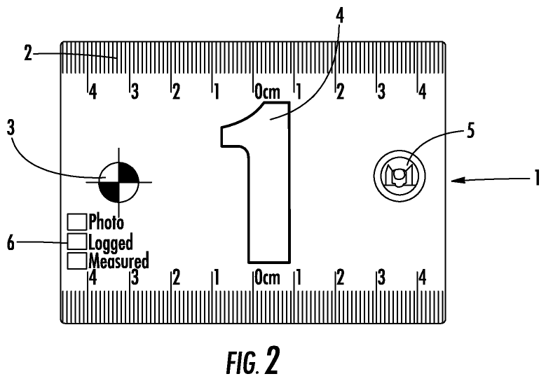

FIG. 2 illustrates one embodiment of the present evidence marker. As shown in FIG. 2, the present evidence markers typically are yellow in color. However, any color may be used including white, orange, green, etc. In addition, the markers may be manufactured from any suitable material including but not limited to paper (card stock) or plastic, and may be of any size, including without limitation: Bridge size (2.25×3.5″), Poker size (2.5×3.5″), Large size (3.5×5.75″), and Tarot size (2.75×4.75″).

As shown in FIG. 2, each evidence marker 1 may contain graphic content providing one or more of: measurement indicia (English, metric, or other) 2; a perpendicular index for indication of orientation 3; a marker identifier 4 (usually sequential, such as a letter, number, or both); 5 LEA logo or other identifier; and 6 markable progress indicators to show current status of the evidence, for example Photographed, Logged, or Measured.

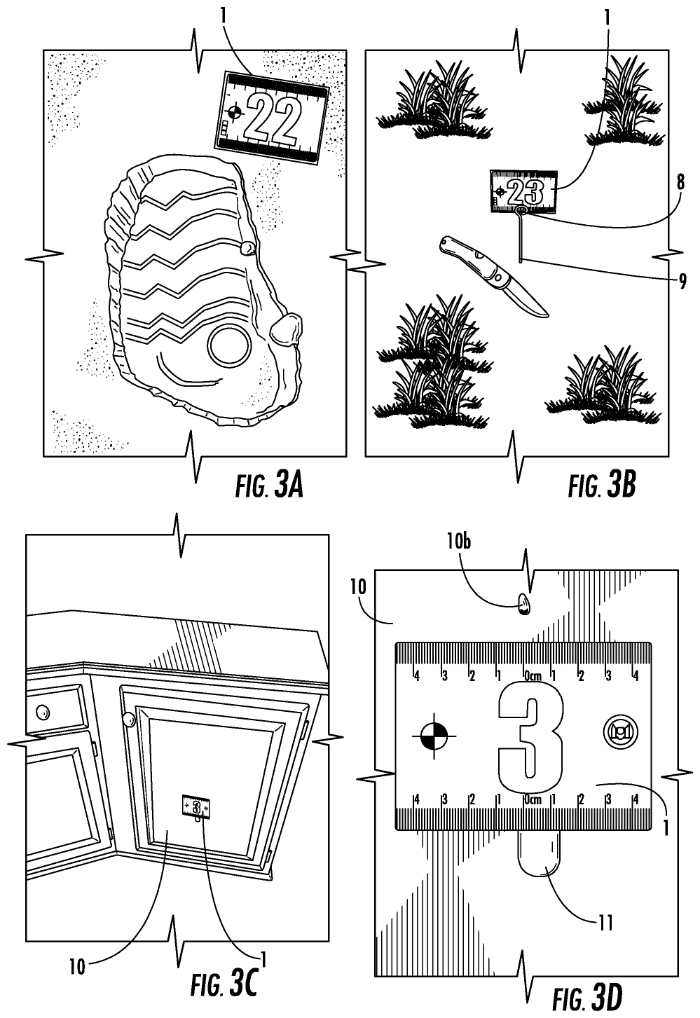

FIGS. 3A-3D show how the present evidence markers may be associated with evidence by a variety of means including: placing the evidence markers on an adjacent surface, whether ground or other; placing the evidence marker in a holder which rests on an adjacent surface; or placing the evidence marker in a holder attached to an adjacent surface, such as magnetically or adhesively.

In particular, FIG. 3A illustrates how an evidence marker 1 may be securely placed next to a footprint in soil by use of a tack, pin, or nail 7 inserted through the marker and into the soil. FIG. 3B illustrates another embodiment for securely holding an evidence marker next to an object located outdoors by means of holder 8 supported by a holder or platform 9.

FIGS. 3C and 3D demonstrate how the present evidence markers may be affixed to a relatively flat surface 10 by means of a holder 11 affixed to the relatively flat surface, shown here in the form of the face of a cabinet. Holder 11, which may be made of any material including plastic, comprises an indentation in which evidence marker 1 rests.

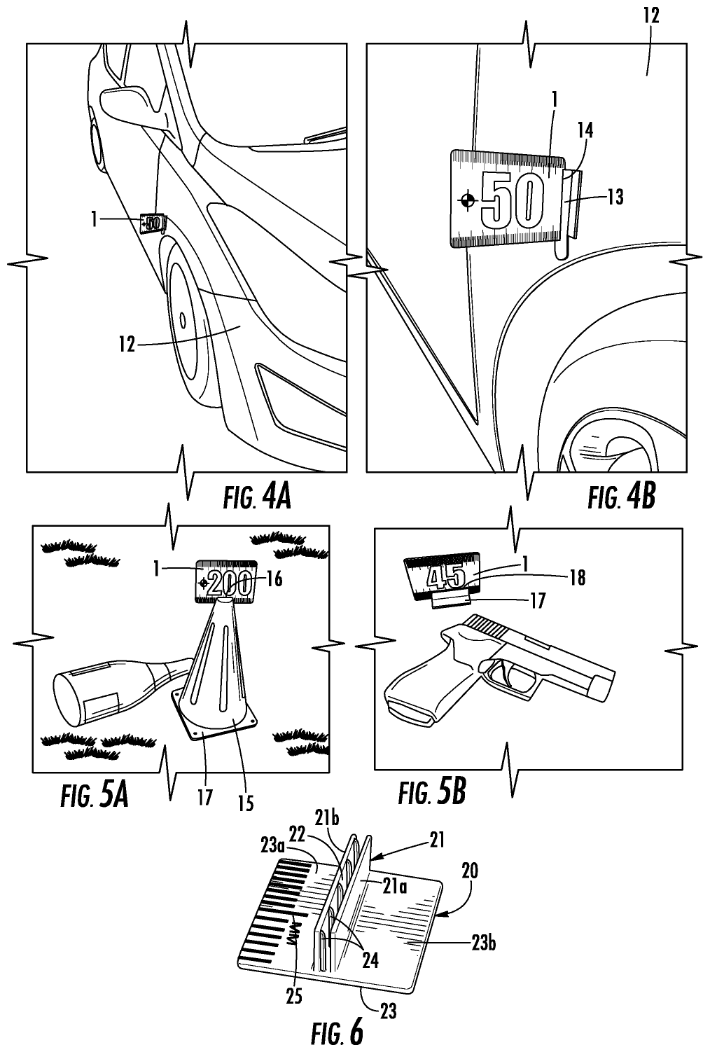

Further means of associating the present evidence markers with evidence is shown in FIGS. 4A-4B, demonstrating how evidence marker 1 may be associated with an object such as an automobile 12 by means of holder 13 bearing a groove 14. Evidence marker 1 slides into groove 14, which holds marker 1 in place.

Additional embodiments shown in FIGS. 5A and 5B, illustrate holder 15 having a base 17 for resting or anchoring the cone on or to the ground or other relatively flat surface. Cone 15 also may have a groove 16 which may be utilized to securely hold present evidence marker 1 on cone 15. In FIG. 5B, present evidence marker 1 is held by holder 15 comprising groove 18 and rectangular platform 19.

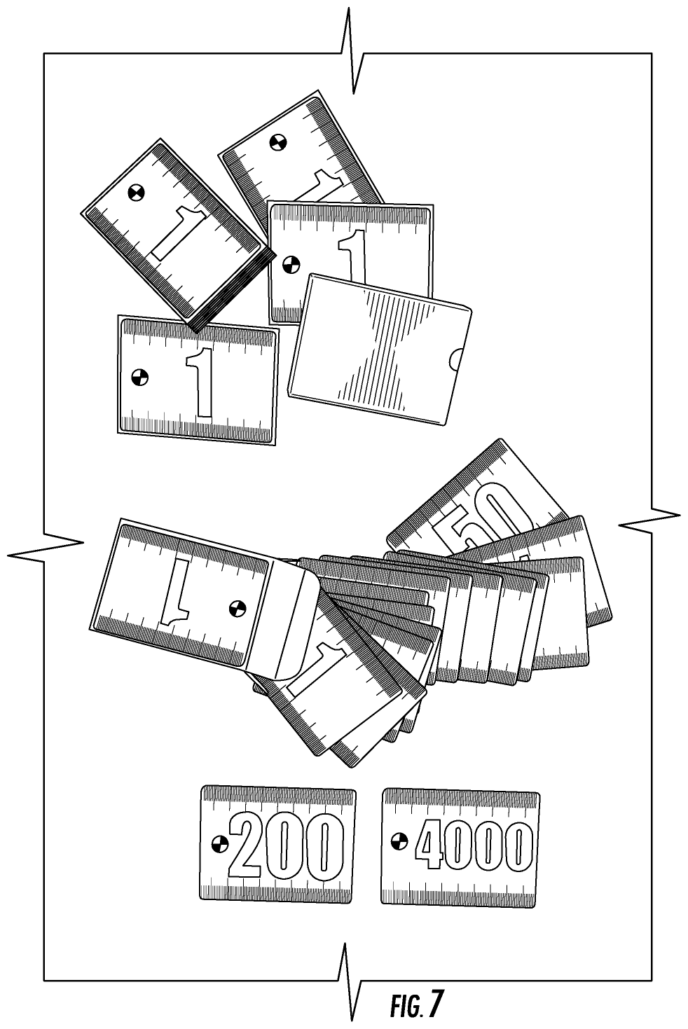

FIG. 6 provides one embodiment of a stand or holder 20 used to hold present evidence marker 1 comprising platform 23. Platform 23 comprises raised portion 21 which may be located approximately equidistant from outer edges 23a and 23b of platform 23. Raised portion 21 comprises walls 21a and 21b located such that a groove 22 is formed therebetween for holding evidence marker card 1. Groove 22 comprises projections 24, which provide a gripping action for present evidence marker 1. Holder 20 may also comprise a scale 25 printed on one or both of outer edges 23a and 23b, for indicating the dimensions of the evidence holder 20 with which it is associated.

The present evidence markers may be supplied in packages or kits as shown in FIG. 7. The present evidence markers 1 may be provided in sequential order and numbered as high as desired. In addition to markers 1, the present evidence marker kits may contain other tools including one or more retractable tape measures, a compact foldable shovel or other similar tool such as a soil claw for digging when necessary, saws to clear branches and the like from outdoor areas where evidence may be found, sifting screens, and one or more magnifying glasses, as well as several evidence marker holders and fasteners.

An initial step in assembling a crime scene investigation kit using the present evidence markers is to print the evidence markers that will be part of the crime scene investigation kit. This entails first creating an electronic file containing the desired characteristics of the markers such as size, color, shape, and any desired graphic content. The file may utilize well-known software including Microsoft Word or Microsoft PowerPoint file. Alternatively, the evidence markers may be produced by custom software, capable of accepting parameters such as the format of the marker identifier (letter, number, alphanumeric) together with first and last values, pertaining to the range of identifier values (such as 1 to 1,000, A to ZZZZ, or A1-A50 to Z1-Z50). Whatever the choice of software, the output file may be printed to produce the markers on a suitable printing apparatus. Such software would preferably also be capable of outputting one or more additional files to: (1) replace missing markers, and/or (2) print additional markers having identifiers that begin where a prior set left off, in case it is realized that the existing set of markers is insufficient.

In addition, stands and holders may be produced for use with the present evidence marking set. The specific types and numbers of stands and holders may be selected based on the known or expected characteristics of a crime scene or may be a mix of types to provide a general-purpose kit for crime scenes that incorporate several types of evidence. The markers and any stands and holders may be packaged into an evidence kit for ready transport to a crime scene.

Once the crime scene kit is deployed to a crime scene, the use of each marker may be recorded; this may be done on paper. A checklist may be generated contemporaneously with use of the markers, reflecting the specific markers involved in sequential order, as well as a listing of the graphic content common to the markers, and/or a sample graphic representation of a marker. Alternatively, the markers can be scanned individually at the time of or after deployment; if after deployment, the markers can be scanned periodically in batches (such as 1-25, then 26-50 and so on), or after all have been deployed. The information on deployed markers can be reviewed and compared to any remaining markers in the evidence kit, as an integrity check to ensure that all markers are accounted for.

If the markers are scanned, they can be scanned in place after being placed at the crime scene so that the scan includes both the marker and the evidence being marked (shell casing, bullet hole, article of clothing, blood, etc.).

After use of the marking kit at the crime scene investigation is considered complete the markers may, depending on chain of custody policy, be (1) retained together, where practicable, with the associated evidence—for example, a shell casing and the associated marker may be placed in the same evidence container; (2) destroyed; or (3) retained for use in a later crime scene investigation.

The record of markers used at a crime scene (whether paper or electronic), may be used in connection with the electronic file that was used to print the markers in order to print a replacement set and restore the evidence kit to full capacity. For example, if an evidence kit is prepared containing markers 1-500, and the crime scene uses markers 1-348, the electronic file may be configured to re-print markers 1-348 in order to restore the evidence kit to full capacity. Thus, in one embodiment, an electronic file may be prepared and used to print a desired number of markers having selected graphic content. The markers may be combined with a set of holders and stands of different types to prepare an evidence kit. The evidence kit will be deployed at a crime scene, with each used marker being scanned to create a record of which particular markers from the kit were used. If there are not enough markers in the evidence kit, the electronic file can be used to produce additional markers that continue the sequence present in the existing markers. The record of used markers may be used to produce a new or revised electronic file that can then be used to print a replacement set of the markers used at the crime scene, restoring the evidence kit to full capacity.

Although the present crime scene evidence marking components and method have been described with reference to particular embodiments, it is to be understood that these embodiments are merely illustrative of the principles and applications disclosed herein. For example, the present evidence markers may be of any suitable material and color, and may present any desired information in alphabetic, numeric, alphanumeric, and/or graphic form. It is therefore to be understood that numerous modifications may be made to the illustrative embodiments and that other arrangements may be devised without departing from the spirit and scope of the present disclosure.

We claim:

1. A marking system for marking evidence at a scene comprising:
a plurality of markers including measurement indicia, a sequential marker identification, and an index for indication of orientation; and
a plurality of holders for holding the plurality of markers, said plurality of holders including a base for resting on a relatively flat surface and a groove for holding the marker in place;
wherein each marker of the plurality of markers is adapted to be placed adjacent to a separate piece of evidence at a scene.

2. The marking system of claim 1, wherein each marker of the plurality of markers are formed of plastic.

3. The marking system of claim 1, wherein each marker of the plurality of markers includes a law enforcement agency logo.

4. The marking system of claim 1 wherein each marker of the plurality of markers includes a progress indicator to show the current status of a corresponding piece of evidence.

5. The marking system of claim 1 wherein each holder of the plurality of holders includes walls and a groove formed therebetween for holding a corresponding marker, wherein each groove includes projections adapted to provide a gripping action for the marker.

6. The marking system of claim 1 wherein each holder of the plurality of holders includes a scale printed on an outer edge thereof for indicating the dimensions of the evidence holder

7. The marking system of claim 1 wherein each holder of the plurality of holders is a cone having a groove formed therein for retaining a marker.

8. A method of marking evidence at a scene with a marking system, said method comprising:
providing a plurality of markers having measurement indicia, a sequential marker identification, and an index for indication of orientation; and
placing said plurality of markers in a plurality of holders, said plurality of holders including a base for resting on a relatively flat surface and a groove for holding the marker in place;
placing each marker and holder adjacent to a separate piece of evidence at a scene.

9. The method of marking of claim 8, wherein each marker of the plurality of markers are formed of plastic.

10. The method of marking of claim 8, wherein each marker of the plurality of markers includes a law enforcement agency logo.

11. The method of marking of claim 8, wherein each marker of the plurality of markers includes a progress indicator to show the current status of a corresponding piece of evidence.

12. The method of marking of claim 8, wherein each holder of the plurality of holders includes walls and a groove formed therebetween for holding a corresponding marker, wherein each groove includes projections adapted to provide a gripping action for the marker.

13. The method of marking of claim 8, wherein each holder of the plurality of holders includes a scale printed on an outer edge thereof for indicating the dimensions of the evidence holder

14. The method of marking of claim 8, wherein each holder of the plurality of holders is a cone having a groove formed therein for retaining a marker.

15. The method of marking of claim 8, further comprising: creating an electronic file containing the characteristics of the markers such as size, color, shape, and any desired graphic content.

16. The method of marking of claim 15, further comprising scanning each marker individually at the time of or after deployment.

17. The method of claim 16, further comprising compiling an evidence kit from the plurality of makers and plurality of holders.

18. The method of claim 17, wherein a record of used markers may be used to produce a new or revised electronic file that can then be used to print a replacement set of markers used at a scene, thus restoring the evidence kit to full capacity.
